(19) United States
(12) Patent Application Publication
(10) Pub. No.: US 2010/0283693 A1
(43) Pub. Date: Nov. 11, 2010

(54) Wireless Terminal Antenna

(75) Inventors: Yanping XIE, Shenzhen (CN); Shaoqing CHEN, Shenzhen (CN); Ping LEI, Shenzehn (CN); Yongling BAN, Shenzhen (CN); Shuhui SUN, Shenzhen (CN); Yao LAN, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI DEVICE CO., LTD., Shenzhen (CN)

(21) Appl. No.: 12/825,042

(22) Filed: Jun. 28, 2010

Related U.S. Application Data
(63) Continuation of application No. PCT/CN2008/073808, filed on Dec. 29, 2008.

(30) Foreign Application Priority Data
Dec. 28, 2007 (CN) 200720196651.8

(51) Int. Cl. H01Q 1/36; H01Q 1/00

(52) U.S. Cl. 343/729; 343/901

(57) ABSTRACT

A wireless terminal antenna is disclosed. The antenna includes a pull rod, a pull rod pedestal located at the base of the pull rod, and a spiral coil. One end of the spiral coil is electrically connected with the pull rod pedestal. The pull rod is axially retractable along the pull rod pedestal until it is retracted into the space enclosed by the spiral coil. At idle time, the pull rod is nested inside the spiral coil so that it is short and portable. When receiving signals normally, the pull rod can be pulled out. The antenna is miniaturized, portable, and provides good performance.

### CROSS-REFERENCE TO RELATED APPLICATIONS

This application is a continuation of International Application No. PCT/CN2008/073808, filed on Dec. 29, 2008, which claims priority to Chinese Patent Application No. 200720196651.8, filed on Dec. 28, 2007, both of which are hereby incorporated by reference in their entireties.

### FIELD OF THE INVENTION

The present invention relates to a wireless terminal antenna technology, and in particular, to an antenna structure of a wireless terminal.

### BACKGROUND

Wireless terminals such as wireless card for accessing Internet, Digital Video Broadcasting (DVB) card, and mobile phone are developing toward miniaturization. The antennas of wireless terminals also need to be miniaturized and suit the size of the wireless terminal. The point is that a miniaturized antenna needs to provide the necessary performance. For example, with the implementation of the DVB standard, various wireless portable terminals (wireless data card, DVB card) capable of receiving DVB programs are more and more popular in the market. In receiving DVB signals on a wireless portable terminal, the main challenge is the design of a broadband antenna that can cover both DVB-V (170 MHz-240 MHz) and DVB-U (470 MHz-860 MHz). Currently, two solutions to DVB antennas are available on the market. One is a monopole antenna, which is 390 mm at length, too large and inconvenient for carrying, and not miniaturized; and the other is an active antenna, which is about 150 mm at length and is seldom applied because it requires a power supply.

In conclusion, a solution to miniaturized portable antennas of good performance is still pending.

### SUMMARY

The embodiments of the present invention provide a portable miniaturized wireless terminal antenna.

A wireless terminal antenna provided in an embodiment of the present invention includes: a pull rod, a pull rod pedestal located at the base of the pull rod, and a spiral coil. One end of the spiral coil is electrically connected with the pull rod pedestal. The pull rod is axially retractable along the pull rod pedestal until it is retracted into the space enclosed by the spiral coil. At idle time, the pull rod is nested inside the spiral coil so that it is short and portable. When receiving signals normally, the pull rod can be pulled out. The antenna is miniaturized and portable, and provides good performance.

### BRIEF DESCRIPTION OF THE DRAWINGS

FIG. 1 shows a structure of a DVB antenna when the antenna is idle;

FIG. 2 shows a structure of a DVB antenna when the antenna works and the pull rod is pulled out of the cone-shaped chassis;

FIG. 3 shows a structure of an antenna with a multi-layered cable; and

FIG. 4 shows a structure of an antenna with a multi-layered cable.

### DETAILED DESCRIPTION OF THE EMBODIMENTS

The embodiments of the present invention are described below in more detail with reference to accompanying drawings.

A portable wireless terminal antenna provided in an embodiment of the present invention includes a pull rod and a spiral coil. The pull rod is axially retractable along a pull rod pedestal until it is retracted into the space enclosed by the spiral coil. At idle time, the pull rod is nested inside the spiral coil so that it is short and portable. When receiving signals normally, the pull rod can be pulled out. Taking a DVB antenna as an example, when the DVB antenna is idle, the pull rod is nested in the spiral antenna, the total height of the pull rod and the chassis outside the spiral coil can be limited to 70 mm. When the antenna works, the total height of the pull rod and the chassis can be limited to 180 mm.

The embodiments of the present invention are elaborated below.

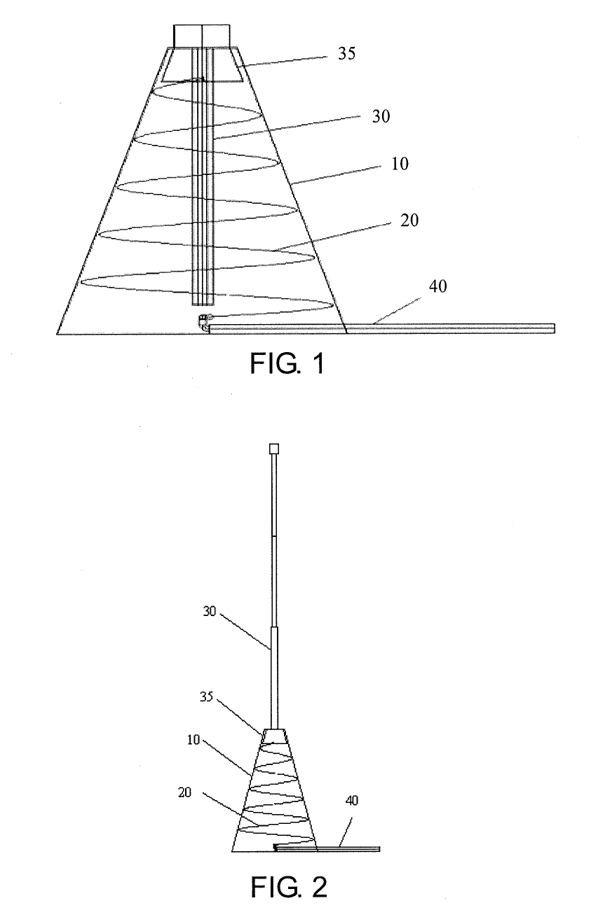

A portable DVB antenna is taken as an example. As shown in FIG. 1 and FIG. 2, the DVB antenna includes: a cone-shaped spiral coil 20, a pull rod 30, and a pull rod pedestal 35 located at the base of the pull rod 30. The spiral coil 20 is electrically connected with the pull rod pedestal 35, and preferably, the electrical connection is welded connection or spring contact.

The DVB antenna may further include a cone-shaped chassis 10, which is a non-conductive cavity that encloses the spiral coil 20 to protect and support it. The cone-shaped chassis 10 can be fixed onto the pull rod pedestal 35, or is connected by other means so that the cone-shaped chassis 10 can enclose the spiral coil and support the antenna. The cone-shaped chassis 10 may be insulating material such as plastic.

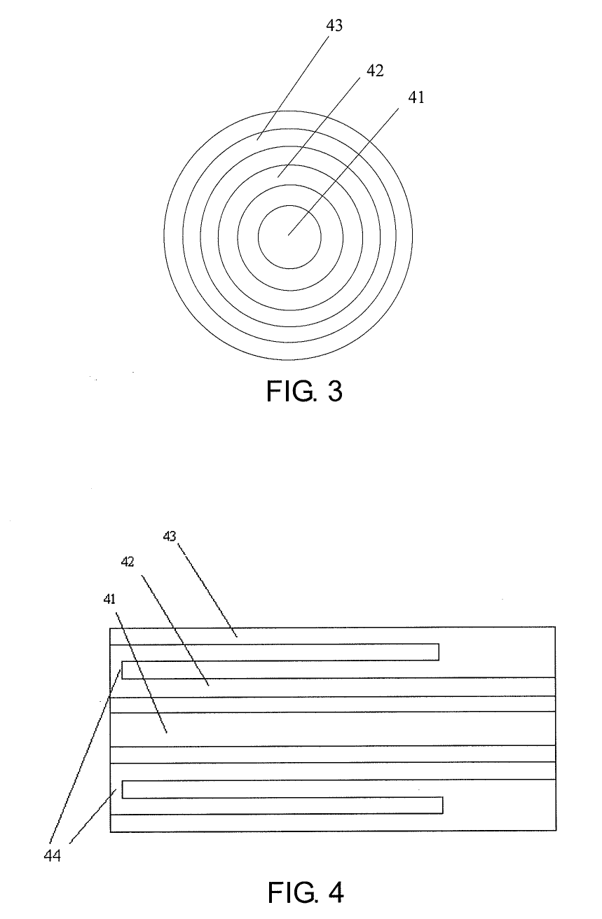

The DVB antenna may include an external multi-layered cable 40 that is treated specially. FIG. 3 and FIG. 4 show the structure of the multi-layered cable 40. The multi-layered cable 40 has three layers of conductors. The innermost conductor is an inner core conductor 41, and the second layer is a metal shielding layer 42. The first metal shielding layer 42 may be a metal wire shielding mesh. The third layer is also a metal shielding layer 43, which may also be a metal wire shielding mesh. Media 44 are used as stuffing between the metal inner core conductor 41 and the second metal shielding layer 42, and between the second metal shielding layer 42 and the third metal shielding layer 43. One end of the metal shielding layer 42 is electrically connected with one end of the metal shielding layer 43. The inner core conductor 41 at one end of the multi-layered cable 40 is connected with the base of the cone-shaped spiral coil 20. The third metal shielding layer 43 is intercepted (open circuit in the microwave band) at a specific length point. This length point is determined through testing according to the size of the multi-layered cable 40. After this length point, the multi-layered cable 40 changes to a conventional coaxial cable structure, namely, it includes only an inner layer conductor 41 and one metal shielding layer. When the antenna is idle, the pull rod 30 is retracted into the space enclosed by the spiral coil 20. When the antenna receives the DVB signals normally, the pull rod 30 is pulled out. The pull rod antenna 50 may be an ordinary pull rod structure. The pull rod 30 of the pull rod antenna 50 can slide downward along the pull rod pedestal 35 so that the pull rod can be nested in the space enclosed by the spiral coil 20.

The cone-shaped spiral coil and the cone-shaped chassis are only a preferred embodiment. The cone-shaped chassis is easy to carry and use, and the tapered structure is handsome and steady. Other shapes such as cylindrical spiral coil or cylindrical chassis, and cubic or box-shaped spiral coil or chassis are also applicable.

The DVB antenna disclosed herein can cover both DVB-V (170 MHz-240 MHz) and DVB-U (470 MHz-860 MHz), and is characterized by easy carrying, low height, and high electrical performance.

Although the foregoing embodiments takes the DVB antenna as an example, such a structure is not only applicable to the DVB antenna, but also applicable to designing antennas on other bands, for example, FM antenna, GSM antenna, WCDMA antenna, and so on.

The forgoing are merely preferred embodiments of the present invention, and it is apparent that those skilled in the art can make various modifications or improvements without departing from the principle of the present invention, which shall also fall within the scope of the present invention.

What is claimed is:

1. A wireless terminal antenna, comprising:
a pull rod;
a pull rod pedestal, located at a base of the pull rod; and
a spiral coil, wherein one end of the spiral coil is electrically connected with the pull rod pedestal; and the pull rod is axially retractable along the pull rod pedestal until it is retracted into a space enclosed by the spiral coil.

2. The wireless terminal antenna of claim 1, wherein:
the wireless terminal antenna further comprises a chassis, and the chassis is a non-conductive cavity which encloses the spiral coil.

3. The wireless terminal antenna of claim 2, wherein:
the chassis is cone-shaped.

4. The wireless terminal antenna of claim 1, wherein:
the spiral coil is cone-shaped.

5. The wireless terminal antenna of claim 1, wherein:
the wireless terminal antenna is a Digital Video Broadcasting (DVB) antenna.

6. The wireless terminal antenna of claim 1, wherein:
the wireless terminal antenna further comprises a cable, where an inner core conductor at one end of the cable is electrically connected with a base of the spiral coil.

7. The wireless terminal antenna of claim 6, wherein:
the cable has three layers of conductors: an innermost layer is an inner core conductor, a second layer is a metal shielding layer, a third layer is also a metal shielding layer, media are used as stuffing between the second metal shielding layer and the third metal shielding layer, and one end of the second metal shielding layer is electrically connected with one end of the third metal shielding layer.

8. The wireless terminal antenna of claim 7, wherein:
the third metal shielding layer is intercepted at a preset length point.
